(19) United States
(12) Patent Application Publication
(10) Pub. No.: US 2015/0101187 A1
(43) Pub. Date: Apr. 16, 2015

(54) MAGNET ORIENTATION AND POSITIONGING SYSTEM, METHOD AND APPARATUS

(71) Applicant: Vastostar Inc., Mentor, OH (US)

(72) Inventors: Paul L. Erickson, Eastlake, OH (US); Roger W. Frantz, Mentor, OH (US); Todd C. Jean, Perry, OH (US); Mark G. Frantz, Shelter Island, NY (US)

(73) Assignee: Vastostar Inc., Mentor, OH (US)

(21) Appl. No.: 14/397,741

(22) PCT Filed: Jun. 14, 2013
(86) PCT No.: PCT/US2013/045840

§ 371 Date: Oct. 29, 2014

Related U.S. Application Data
(60) Provisional application No. 61/660,346, filed on Jun. 15, 2012.

(51) Int. Cl. B23P 11/00

(52) U.S. Cl. CPC B23P 11/00
USPC 29/729; 29/700

(57) ABSTRACT

An apparatus (100) for orienting magnetic elements (14) for assembly on a flexible elongated core member (12) includes a plate (104) for supporting the magnetic elements (14). A plurality of magnetic positioning elements (150) are secured to the plate (104) and are configured to position and orient the magnetic elements (14) to facilitate assembly of the elements (14) on the core member (12).

### RELATED APPLICATION

This application claims the benefit of U.S. Provisional Application Ser. No. 61/660,346, filed on Jun. 15, 2012.

### SUMMARY

The invention relates to a system, method and apparatus to allow for the efficient assembly of a single magnet or multiple magnets, with or without additional parts. According to one aspect, the invention relates to a method of orienting the magnetic poles and position of a magnet(s), and optionally other element(s) in combination with the magnet(s). The method includes the use of a propositioned magnet(s) or ferromagnetic/ferrimagnetic material in a fixture that mates with the magnet(s)/element(s) to be oriented and positioned. According to another aspect, the invention relates to an apparatus that has retention slots or other means to maintain the position and pole orientation of a magnet(s) or position of a ferromagnetic/ferrimagnetic material in relation to a second magnet(s), and optionally other element(s). Such apparatus may be a multi-level fixture with prepositioned magnet(s) on one level and the magnet(s)/element(s) to be oriented and positioned on a second mating level. Alternatively, the fixture may locate the magnet(s)/element(s) to be oriented and positioned on the same plane as the prepositioned magnet(s). The apparatus may also allow for the introduction of a securing means to hold such magnet(s)/element(s) oriented and positioned once removed from the fixture.

According to one aspect of the invention, an apparatus for orienting magnetic elements for assembly on a flexible elongated core member includes a plate for supporting the magnetic elements. A plurality of magnetic positioning elements are secured to the plate and are configured to position and orient the magnetic elements to facilitate assembly of the elements on the core member.

### BRIEF DESCRIPTION OF THE DRAWINGS

The invention may be best understood by reference to the following description taken in conjunction with the accompanying drawing figures in which:

FIG. 1 is a perspective view illustrating example configuration of an article of manufacture comprising a core member with a plurality of elements affixed thereto;

FIG. 2 is a perspective view illustrating an apparatus for orienting and positioning elements in an article of manufacture, such as the article of manufacture illustrated in FIG. 1, according to an embodiment of the invention;

FIG. 3 is a perspective view illustrating a bottom surface of the apparatus of FIG. 2;

FIG. 4 is a magnified perspective view illustrating a portion of the bottom surface of the apparatus shown in FIG. 3;

FIG. 5 is a further magnified perspective view illustrating a portion of the bottom surface of the apparatus shown in FIGS. 3 and 4;

FIG. 6 is a magnified perspective view illustrating an element positioning function of a portion of the apparatus;

FIG. 7 is a magnified sectional view illustrating the element positioning function of the portion of the apparatus;

FIG. 8 is a magnified perspective view illustrating the assembly of an article of manufacture, such as the article illustrated in FIG. 1, using the apparatus;

FIG. 9 is a magnified sectional view illustrating the assembly of the article of manufacture using the apparatus;

FIG. 10 is a magnified view from a different perspective illustrating the assembly of the article of manufacture using the apparatus;

FIG. 11 is a perspective view illustrating the apparatus with a cover assembled thereto;

FIG. 12 is a magnified sectional view illustrating the assembly of an article of manufacture, such as the article of manufacture illustrated in FIG. 1, using the apparatus of FIG. 11;

FIG. 13 is the perspective view of the apparatus shown in FIG. 11, with the cover shown translucent in order to illustrate the assembly of the article of manufacture;

FIG. 14 is a magnified sectional view illustrating the assembly of the article of manufacture using the apparatus of FIG. 11;

FIG. 15 is a perspective view illustrating an apparatus for orienting and positioning elements in an article of manufacture, such as the article of manufacture of FIG. 1, according to a second embodiment of the invention;

FIG. 16 is a perspective view of the apparatus of FIG. 15 with a portion removed;

FIG. 17 is a perspective view of the apparatus of FIG. 16 with a portion magnified to show the detail of its construction;

FIG. 18 is a perspective view of a portion of the apparatus illustrated in FIG. 15;

FIG. 19 is a magnified perspective view of a portion of the apparatus illustrated in FIG. 18;

FIG. 20 is a magnified perspective view of a portion of the apparatus illustrated in FIG. 15;

FIG. 21 is a top plan view illustrating the assembly of an article of manufacture using the apparatus of FIG. 15;

FIG. 22 is a magnified perspective, partially sectional view of a portion of the apparatus being used to assemble the article of manufacture; and

FIG. 23 is a perspective view of the apparatus of FIG. 15 with a portion magnified to show the detail of its construction.

### DESCRIPTION

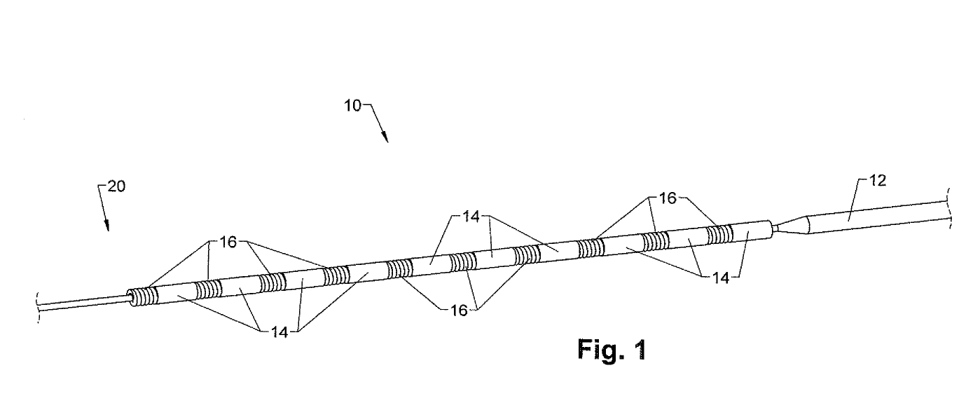

The invention relates to a system, method and apparatus for orienting and positioning magnetic elements in an article of manufacture. According to one example, the invention relates to a method and apparatus for orienting and positioning magnetic elements on a core member, such as a flexible elongated core member. Referring to FIG. 1, the invention may, in one particular example, relate to a method and apparatus for use in the manufacture of a guidewire 10. The example guidewire of FIG. 1 includes a flexible elongated core member, core 12, upon which one or more magnetic elements, permanent magnets 14 are mounted. In the example of FIG. 1, the guidewire includes spacer elements in the form of spring-like coiled spacers 16 positioned between the magnets 14. According to one particular example, the guidewire 10 may be a portion of a medical device in which the guidewire is advanced through occlusions in a body lumen. In this example, it is a lead or distal end portion 20 of the guidewire 10 that is fit with the magnets 14 and spacers 16.

The guidewire 10 of FIG. 1 may be any conventional guidewire used in medical applications.

According to one particular example, the diameter of the proximal shaft and diameter of the spring coil distal tip are 0.014″. In this example, the diameter of the magnet/spacer section of the core 12 is in the range of 0.014 to 0.016″. The magnet-to-magnet period is 2 mm. In this example, the length of the magnets 14 is in the range of about 1.0 to 1.5 mm, for example 1.4 mm.

The spacers 16 could have multiple designs. For example, the illustrated spring coil spacers 16 could have alternative configurations, such as plastic or metal solid tubes, plastic or metal spiral cut tubes, or overmolded plastic. Any suitable metal could be used, such as stainless steels, cobalt-based alloys (e.g., MP35N or Elgiloy), platinum or platinum alloys, titanium or titanium alloys, and nitinol.

The magnets 14 and spacers 16 can be bonded to the core wire with any suitable adhesive (eg: cyanoacrylate, epoxy, etc), then jacketed with a thin heat shrink tube, e.g., polyester, specifically polyethylene terephthalate (PET). A hydrophilic or hydrophobic coating, alone or in some combination, can then be applied to the spring coil distal tip (not shown) and the magnet/spacer section.

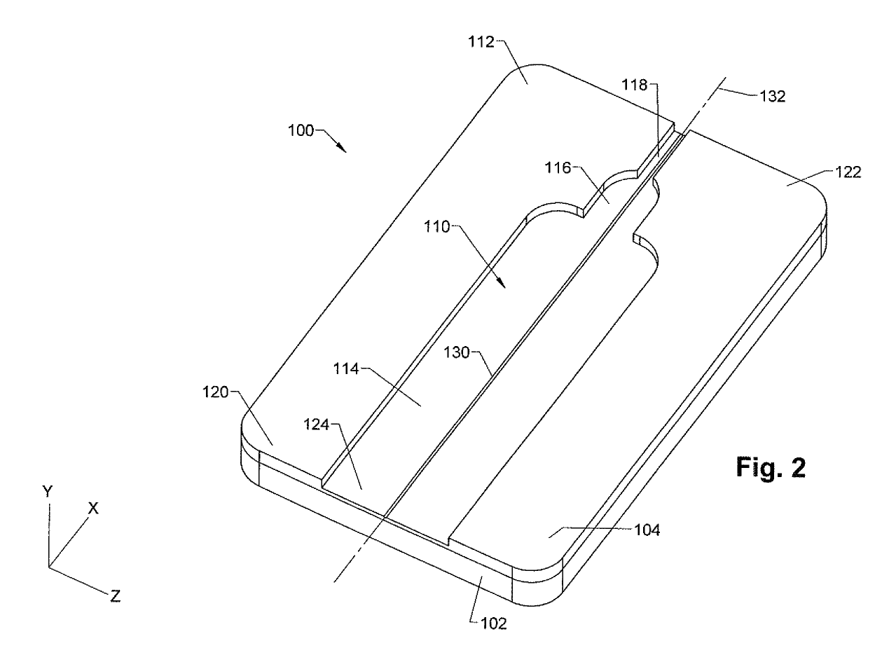

FIG. 2 is a perspective view illustrating an apparatus 100 for orienting and positioning magnetic elements in an article of manufacture. The apparatus 100 forms a portion, in the form of an assembly fixture, of the system described herein. The apparatus 100 may, for example, be used to orient and position magnetic elements on a core member, such as a flexible elongated core member. According to one particular example, the apparatus 100 may be for orienting and positioning magnetic elements on a guidewire, such as the guidewire 10 of FIG. 1. In this description, reference may be made to the X, Y, and Z axes or directions, which are shown in the drawings.

In the example embodiment of FIG. 2, the apparatus 100 includes a base plate 102 and a top plate 104 that are connected or bonded together in a suitable manner. Alternatively, the apparatus 100 could include additional layers of material (La, plates) or could be constructed of a single layer/plate of material. According to one example construction, the top plate 104 may be constructed of, or be coated with, a polytetrafluoroethylene (PTFE) material, which is available commercially as Teflon® from the E. I. du Pont de Nemours and Company of Wilmington, Del. Any other suitable material or combination of materials can be used. The materials for the top plate and the base plate can be selected from materials that are nonmagnetic. Nonmagnetic materials have little reaction to magnetic fields (ie: they have a relative permeability close to unity), and do not produce a magnetic field.

The apparatus 100 of the example embodiment of FIG. 2 has an overall generally rectangular configuration. Alternative shapes could be utilized. The top plate 104 includes a work area 110 that is recessed (e.g., via machining or molding) into a top surface 112 of the plate (i.e., in the Y-direction). The work area 110 includes a first portion 114, second portion 116, and third portion 118 that are linearly arranged and extend from a first end 120 to an opposite second end 122 of the top plate 104. The portions 114, 116, and 118 are contiguous and generally rectangular in form. The first portion 114 is positioned at the first end 120 of the top plate 104 and the third portion 118 is positioned at the second end 122 of the top plate, with the second portion 116 being positioned therebetween. The first portion 114 is the largest of the work area portions and forms the primary work area of the apparatus 100.

The work area 110 includes a work surface 124 that is recessed into the top plate 104 and that extends throughout the work area 110. The top plate 104 also includes a channel 130 that is recessed (e.g., via machining or molding) further into the top plate 104, i.e., recessed into or beneath the work surface 124. The channel 130 extends the entire length of the top plate 104, extending through the first end 120 and the second 122. The channel 130 is centered and extends linearly through each of the first 114, second 116, and third 118 portions of the work area 110. The channel 130 is centered on an axis 132 that essentially defines the central, primary axis of the apparatus 100 in the X-direction. Those skilled in the art will appreciate that the position and shape of the channel 130 relative to other features may take on any suitable arrangement. For example, the channel 130 may be offset from the center of the work area 110. In another example, the channel 130 may extend through each of the first 114, second 116, and third 118 portions of the work area 110 along a curvilinear path.

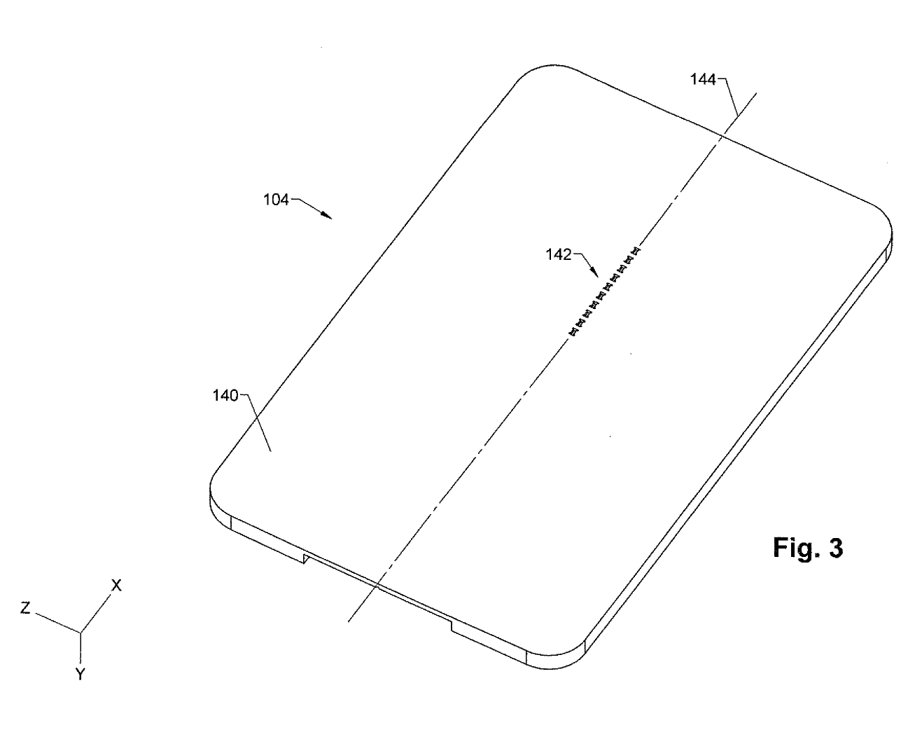

FIG. 3 is a perspective view illustrating a bottom surface 140 of the top plate 104. The top plate 104 includes a plurality of means, in the form of pockets 142, for receiving elements, e.g., magnetic elements (such as permanent magnets, electromagnets, ferromagnetic elements, ferrimagnetic elements), and securing the elements to the top plate. The pockets 142 are recessed (e.g., via machining or molding) into the bottom surface 140 and are arranged linearly along an axis 144 that extends parallel to the axis 132 (see FIG. 2). In the illustrated embodiment, the axis 144 is parallel to the axis 132 and is spaced from the axis 132 in the Y-direction only.

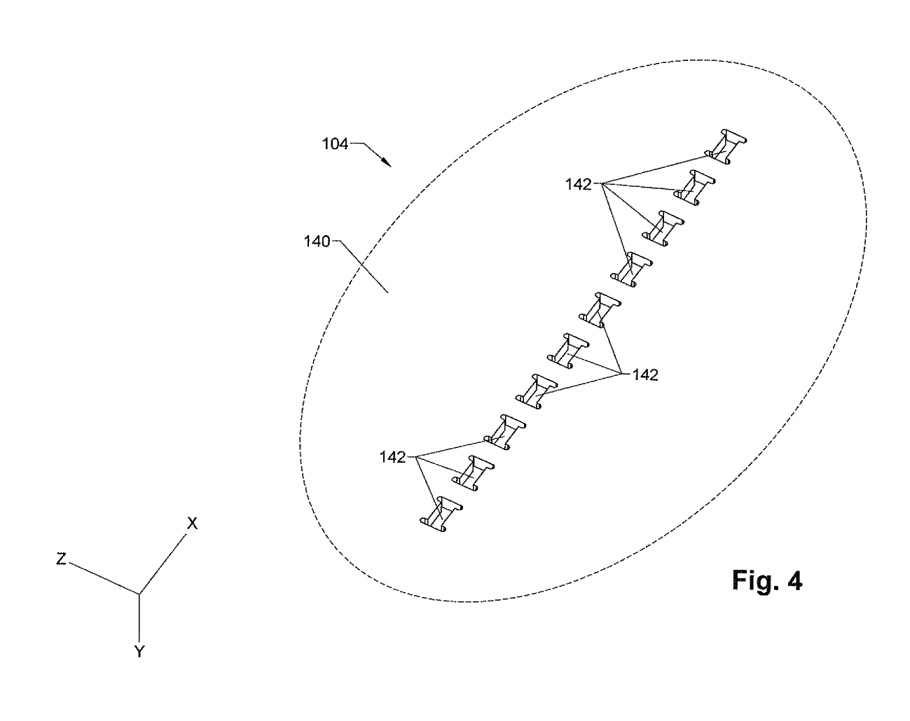

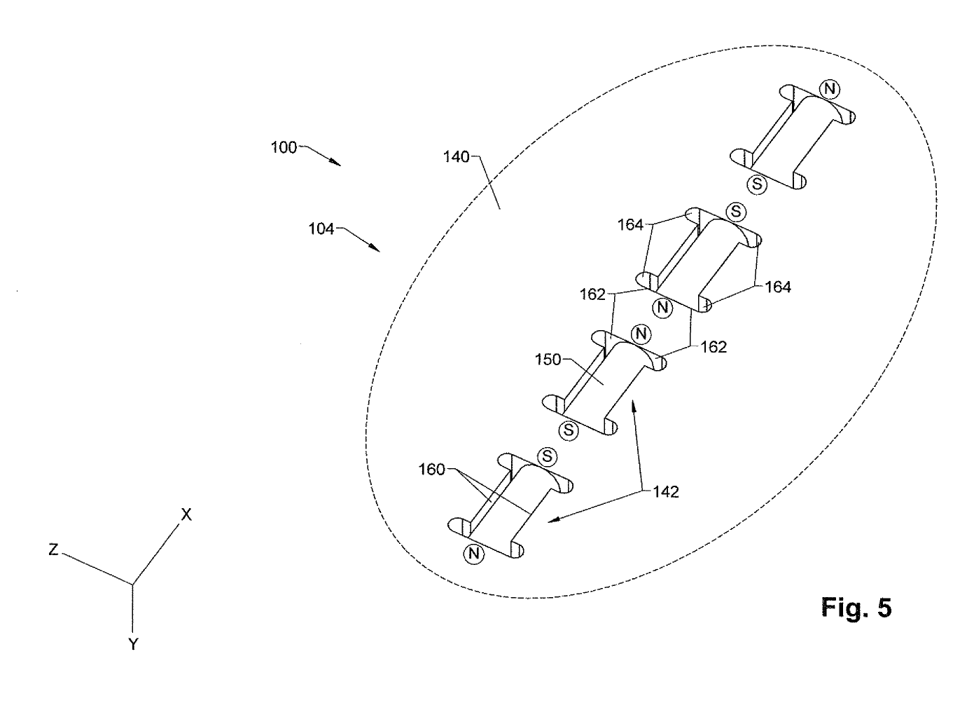

Referring to the magnified views of FIGS. 4 and 5, the pockets 142 are generally elongated and rectangular in form, each having spaced, opposing side walls 160 and spaced, opposing end walls 162 that extend transverse to the side walls. The pockets 142 each receive and support an element 150 (e.g., magnetic element) on the base plate 102. In the example embodiment, the elements 150 are permanent magnets, each of which has a generally cylindrical shape (although any suitable shape may be used) and that are axially magnetized (direction of magnetization is through their length). The poles of each element 150 are indicated by a circled “N” for north pole and a circled “S” for south pole. In the embodiment illustrated in FIG. 5, the elements 150 are arranged with like poles adjacent to each other. The elements 150 could, however, have any desired arrangement, such as opposite poles adjacent to each other or any combination of like or alternating polarities positioned adjacent and/or facing to each other.

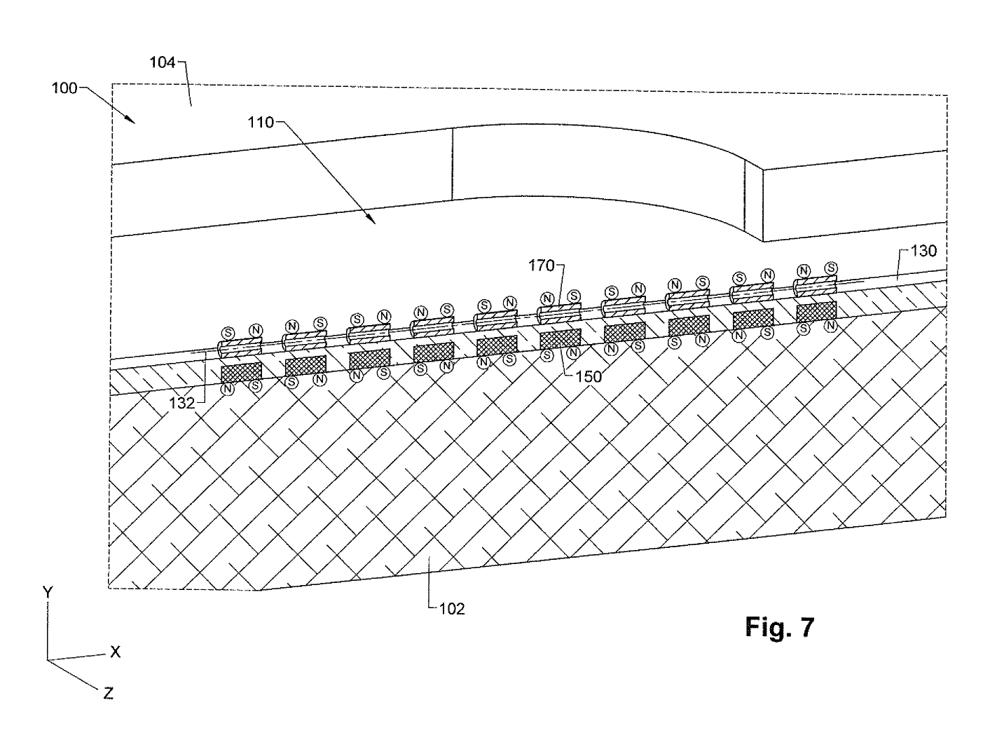

The pockets 142 each include end portions 164 that extend transverse to the axis 144 beyond sidewalls 160. The end portions 164 are corner relief features and are the result of machining the pockets 142 with a round cutting tool. End portions 164 may or may not be present, depending on the manufacturing process used to create pockets 142. The end portions 164 could, however, be used advantageously to permit the insertion of a tool for installing, removing, or positioning the elements 150 in the pockets 142. Once the elements 150 are properly positioned, the base plate 102 is attached to the top plate 104 (see FIG. 7) to conceal and maintain the elements 150 in the pockets 142.

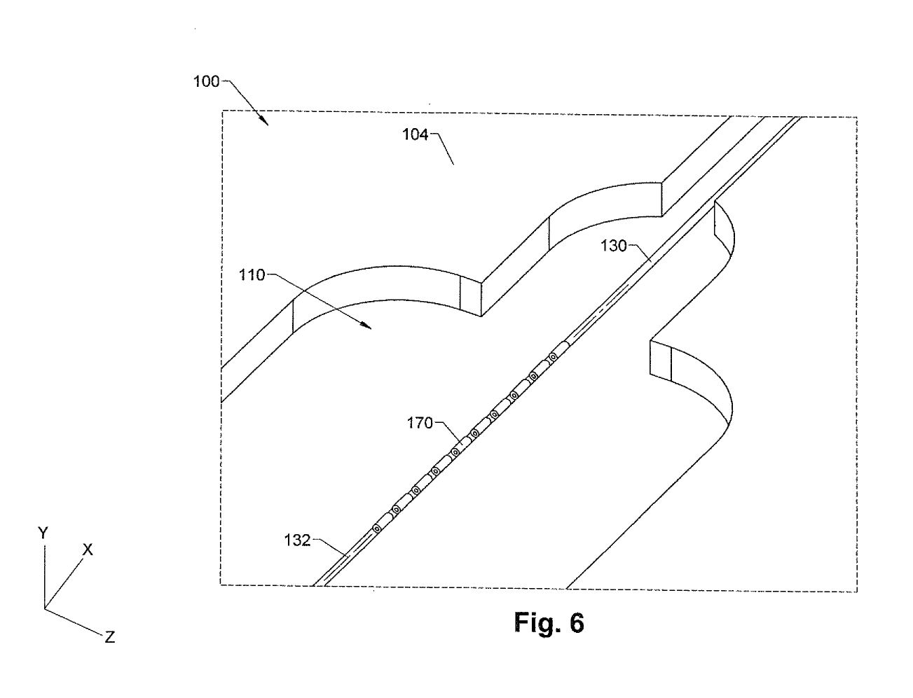

Referring to FIGS. 6 and 7, according to the illustrated example embodiment, the apparatus 100 helps position and maintain the position of magnetic elements (e.g., permanent magnets, ferromagnetic elements, ferrimagnetic elements) or work pieces in the channel 130. In the example embodiment, the elements positioned in the channel 130 are magnetic (permanent magnet) cylindrical beads 170, each of which has a central cylindrical throughbore that extends along its length. The beads 170 are axially magnetically polarized, i.e, the beads 170 are axially magnetized (magnetized through their length)—north pole on one end and south pole on the other. According to the invention, the elements 150, being embedded in the base plate 102 and spaced adjacent and parallel to the channel 130, position the beads 170 in the proper position and orientation (polarity) in the channel. The magnetic elements 150 attract the magnetic beads 170 into the channel 130, position the beads in the channel, and orient the beads with like polarities adjacent to each other as shown in FIG. 7.

Advantageously, the elements 150 draw the beads 170 into the channel 130 due to their inherent, mutually attractive magnetic characteristics. The beads 170, due to their relatively small size and their magnetic properties, would be difficult to position manually. Determining which end of the beads have which polarity and then assembling them in position adjacent to each other as required would be extremely difficult due to the tendency of the beads to attract and repel each other. The apparatus 100 advantageously overcomes these difficulties by implementing elements 150 whose magnetic strength is sufficient to overcome the repelling and/or attracting forces between the adjacent ends of the beads 170. Thus, as shown in FIG. 7, the apparatus 100 is able to maintain the beads 170 as shown, with like polarities facing each other.

Those skilled in the art will appreciate that the position and orientation of the elements 150 can be selected to produce a corresponding desired position and orientation of the beads 170. The apparatus 100 can position the beads at any orientation relative to each other.

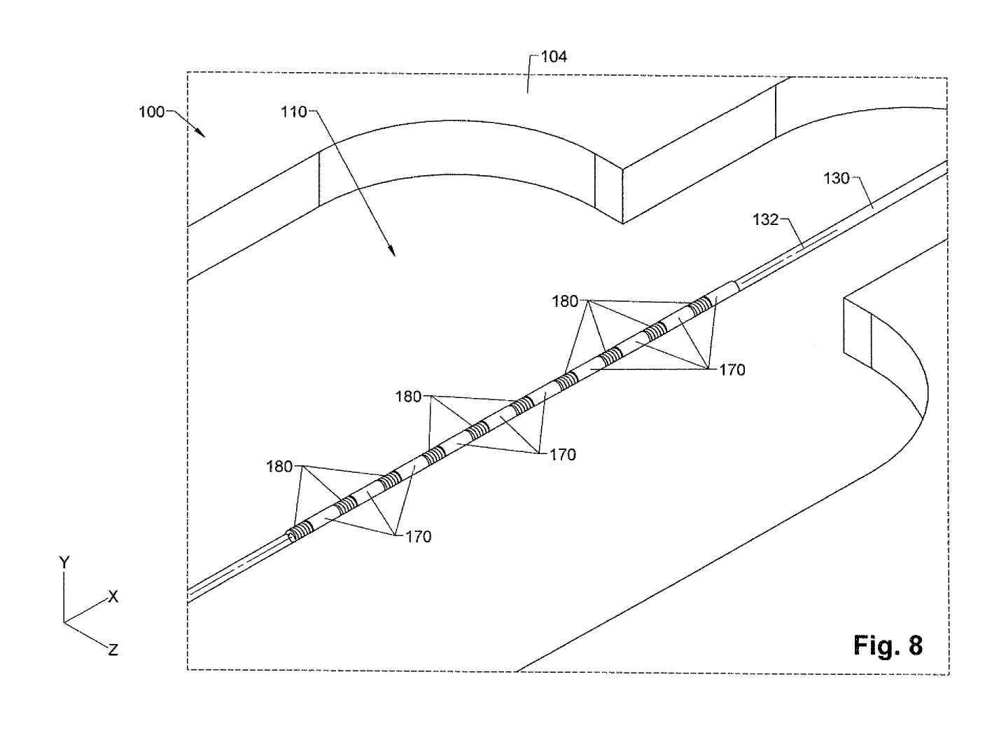

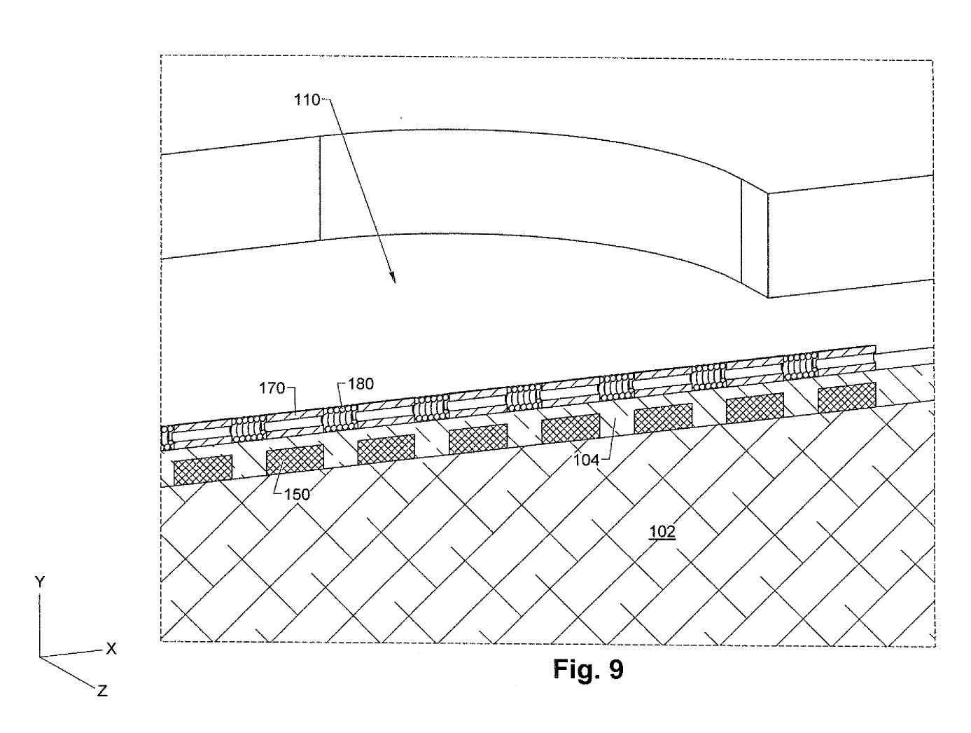

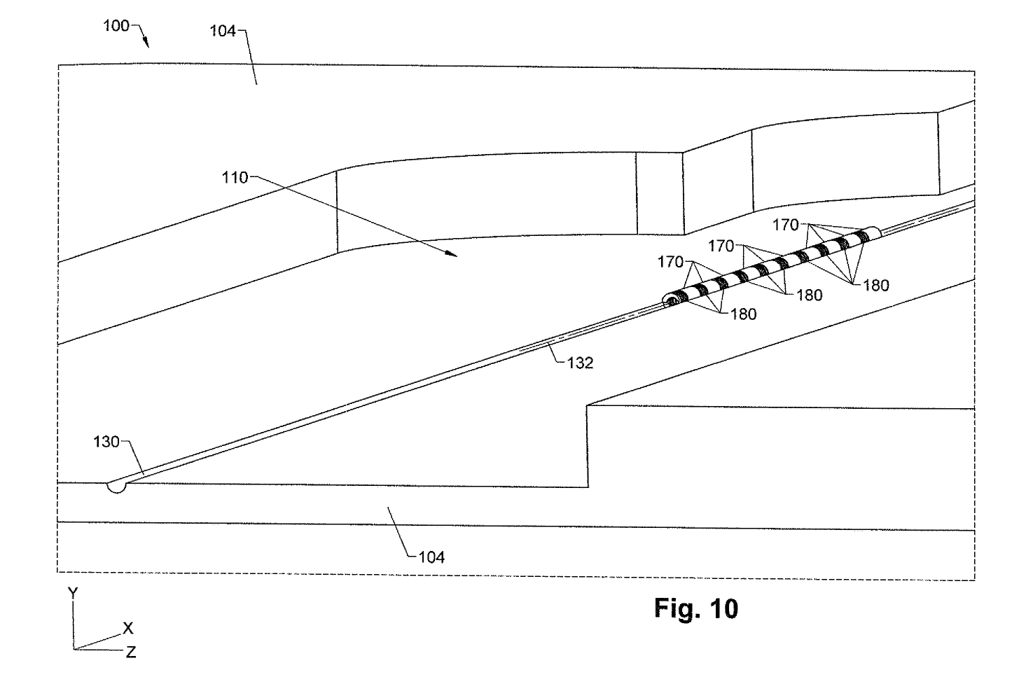

As shown in FIG. 7, the axis 132 along which the channel 130 extends is coaxial or substantially coaxial with the axes of the beads 170. Additionally, the channel 130 may have an arcuate cross-section that mates with the corresponding cylindrical outer surfaces of the beads 170. Alternatively, the channel 130 may have a rectilinear cross-section that mates in a tangential relationship with the cylindrical outer surfaces of the beads 170. The shape, cross-section, and configuration of the channel 130 can be designed to accommodate elements of any shape, size, or configuration. The shape, cross-section, and configuration of the channel 130, in combination with the magnetic attraction of the elements 150 can combine to position the elements/beads 170 in any desired manner. Referring to FIGS. 8 to 10, the channel 130 may also receive spacing elements 180, such as cylindrical coil spring spacers. The spacers 180 have a coiled wire construction that leaves an open, axially extending central aperture that extends along its length and is generally centered on the axis 132. The central aperture of the spacers 180 are thus axially aligned with the throughbores of the beads 170.

The spacers 180 may be constructed of a ferromagnetic material, such as stainless steel, or a non-ferromagnetic material, such as Elgiloy. In the case where the spacers 180 are formed of a ferromagnetic material, the spacers 180 are held in position in channel 130 by the magnetic forces acting on the spacers 180. The magnetic forces being a result of the magnetic fields produced by elements 150 and beads 170. Those skilled in the art will appreciate that the spacers 180 may take on any suitable configuration. For example, if a coil/spring configuration is used, the cross-section of the coiling wire may round, square, rectangular or any other suitable shape. By way of another example, the spacers 180, if implemented as coil/spring members, may be wound with an open pitch or a closed pitch (i.e., tight wound). In addition, the spacers may have a coil diameter that is constant over the length of the coil/spring, or the coil diameter may vary over the length of the coil/spring. Furthermore, the spacers 180 may take on other forms other than coils/springs. For example, the spacing elements may be simple tubes (hollow cylinders) of any suitable metal or plastic. Alternatively, the spacing elements may be tubes where the tubular wall is cut through (by laser of other suitable means) with a spiral or other pattern to provide the element with the desired level of bending and axial stiffness. Additionally, the spacers may be created by overmolding with a plastic resin.

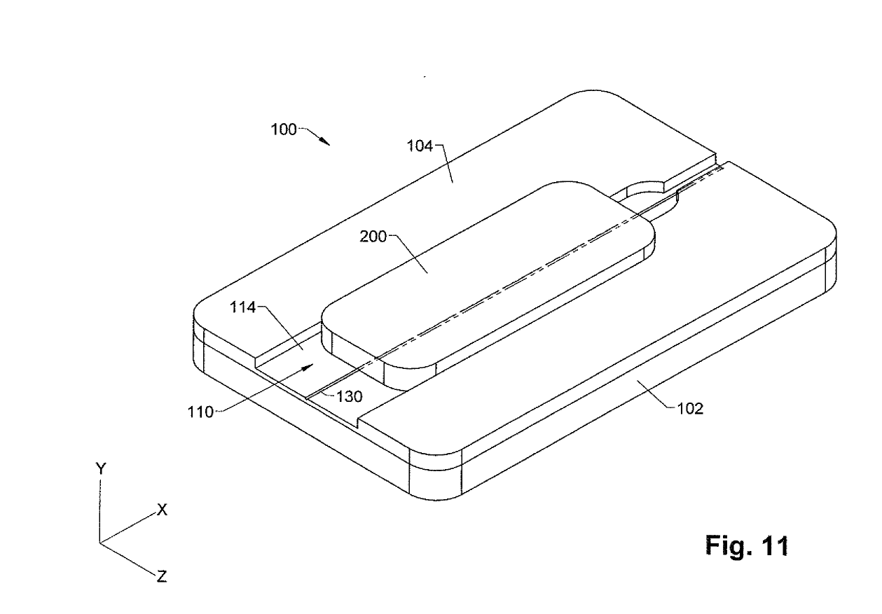

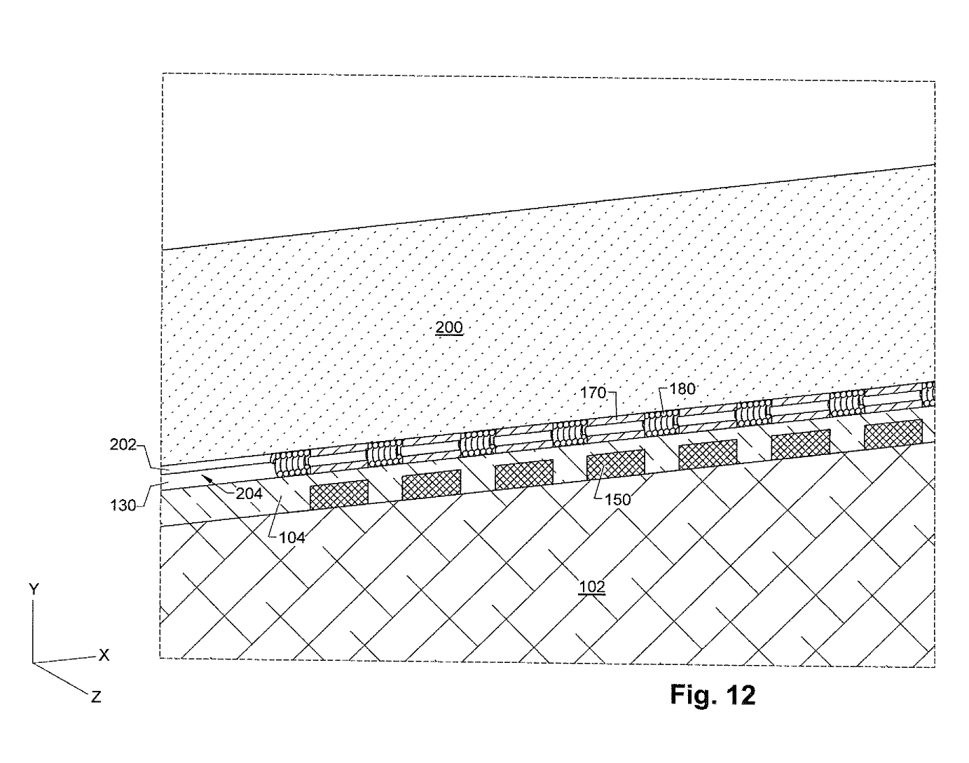

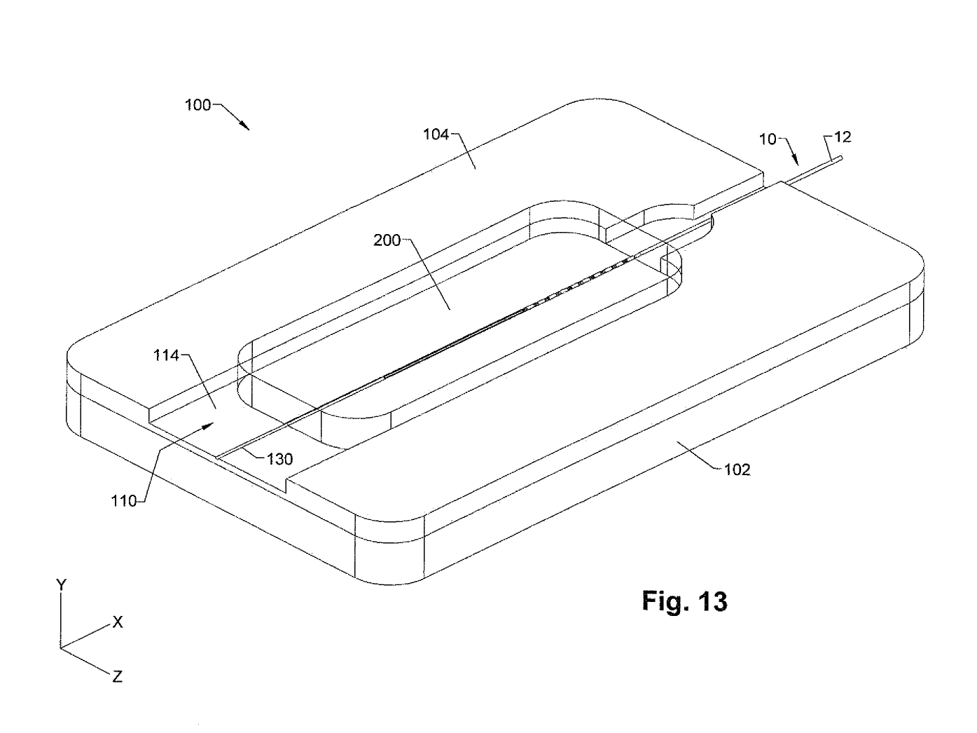

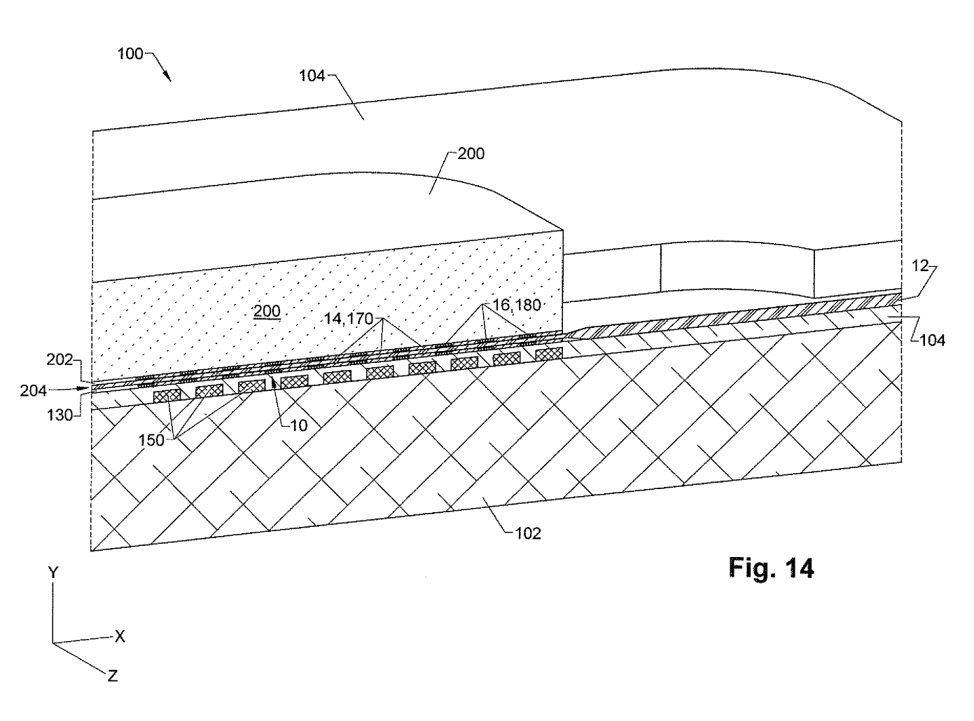

Referring to FIGS. 11 to 14, the apparatus 100 also includes a cover 200. The cover 200 has a generally rectangular form and has a width selected to mate with the width of the first portion 114 of work area 110. The cover 200 also includes a channel 202 that extends throughout its length. The cover 200 is configured such that the channel 202 overlies and is generally coaxial with the channel 130 when the cover is received in the first portion 114 of the work area 110. In the illustrated embodiment, the channel 130 and the channel 202 combine to define a cylindrical space 204 that extends along the axis 132. The cylindrical space 204 defined by the channels 130 and 202 has a diameter that is selected to mate with the core 12, magnetic elements 14, and spacer elements 16 of the guidewire 10 of FIG. 1. The cover 200 can be made from a nonmagnetic material so that it will not magnetically attract magnetic beads 170 which would potentially disturb the positions of magnetic beads 170 and spacers 180. According to one construction, the cover 200 can be made of an optically clear plastic to permit visualization of the underlying train of magnet beads 170 and spacers 180. Those skilled in the art will appreciate that cover 200 may or may not include the channel 202, depending on the cross-sectional shape and depth of the channel 130 in top plate 104.

To use the apparatus 100 to assemble the guidewire 10, the magnetic elements 14, e.g., the magnetic beads 170, are placed in the first portion 114 of the work area 110. The magnetic elements 150 embedded in the top plate 104 will attract the beads 170 into the channel 130 and will position the beads with their magnetic poles in the proper orientation, e.g., with like poles of adjacent beads facing each other. Next, the spacer elements 16, i.e., the spring/coil spacers 180, are inserted into the channel 130 between the beads 170.

Next, the cover 200 is inserted into the first portion 114 of the work area 110. The channel 202 covers the aligned beads 170 and spacers 180. Next, the core 12 of the guidewire 10 is inserted into the space 204 defined by the channels 130 and 202. In doing so, the portion of the channel 130 extending through the second and third portions 116 and 118 of the work area 110 help to guide the core 12 into the space 204. While the core 12 is inserted, the cover 200 serves to help maintain the positions of the bead 170 and spacers 180 so that they do not become dislodged by the insertion of the core. It will be appreciated by those skilled in the art that the size of channels 130 and 202 relative to the size of the guidewire components (e.g., core 12, magnets 14, spacers 16) may be varied to provide any desired fit between the channels 130, 202 and the guidewire components. For example, channels 130, 202 may be sized slightly larger than the magnets 14 and spacers 16 to provide a clearance fit such that the magnets 14 and spacers 16 are simply trapped in between cover 200 and top plate 104 but not forcefully clamped. Alternatively, the depth, in the Y-direction, of channels 130, 202 may be sized slightly smaller than the outer diameters of magnets 14 and spacers 16 such that magnets 14 and spacers 16 are clamped when the cover 200 is inserted into the first portion 114 of the work area 110 and held in place with a downward (Y-direction) force.

Once the core 12 is inserted, the cover 200 can be removed, leaving the assembled guidewire 10, which can then be removed from the apparatus 10. Since the magnetic elements 14 (beads 170), spacer elements (spring/coil spacers 180) and core 12 can be very small diameter items, they can also be fragile. Because of this, it may be desirable that the magnetic elements 150 not be so strong as to risk damage to the guidewire 10 during removal. Therefore, according to the invention, the magnetic elements 150 can be selected to be strong enough to provide the desired orientation of the beads 170, but not so strong as to risk damaging the guidewire 10 during removal from the apparatus 100. The desired level of magnetic attractive force can be provided by varying any one of the following parameters alone or in combination: magnet materials, magnet grades, magnet sizes/shapes, and the distance (Y-direction) between the magnetic beads 170 and the magnetic elements 150.

The apparatus 100 could be adapted or configured with features for facilitating easy removal of the assembled guidewire 10. For example, the magnetic elements 150 could be embedded in a layer separate from the top plate 104. The top plate 104 and this separate layer holding the magnetic elements 150 could be held together during assembly of the guidewire 10 and then separated after assembly so that there is no magnetic resistance to removal of the assembled guidewire. This could be achieved, for example, by connecting the top plate 104 and the layer holding the magnetic elements 150 via a sliding connection or a hinged connection.

By way of another example, the magnetic elements 150 could be implemented as electromagnets. During assembly of the guidewire 10, the electromagnets could be activated with a supplied electric current. While activated, the electromagnets would produce a magnetic field. The magnetic field would act to position the beads 170 in the proper position and orientation (polarity) in the channel 130. After assembly of beads 170 and spacers 180 onto core 12, the electromagnets could be deactivated by removing the supplied electric current. When the electromagnets are in the deactivated state, the electromagents no longer produce a magnetic field, and the assembled guidewire 10 may be easily removed from the apparatus 100 without undue magnetic resistance. Advantageously, in this embodiment, the electromagnets could be electrically wired and/or switched so that the magnetic poles of each electromagnet are selectable, so that the apparatus 100 can adapt to a desired guidewire configuration.

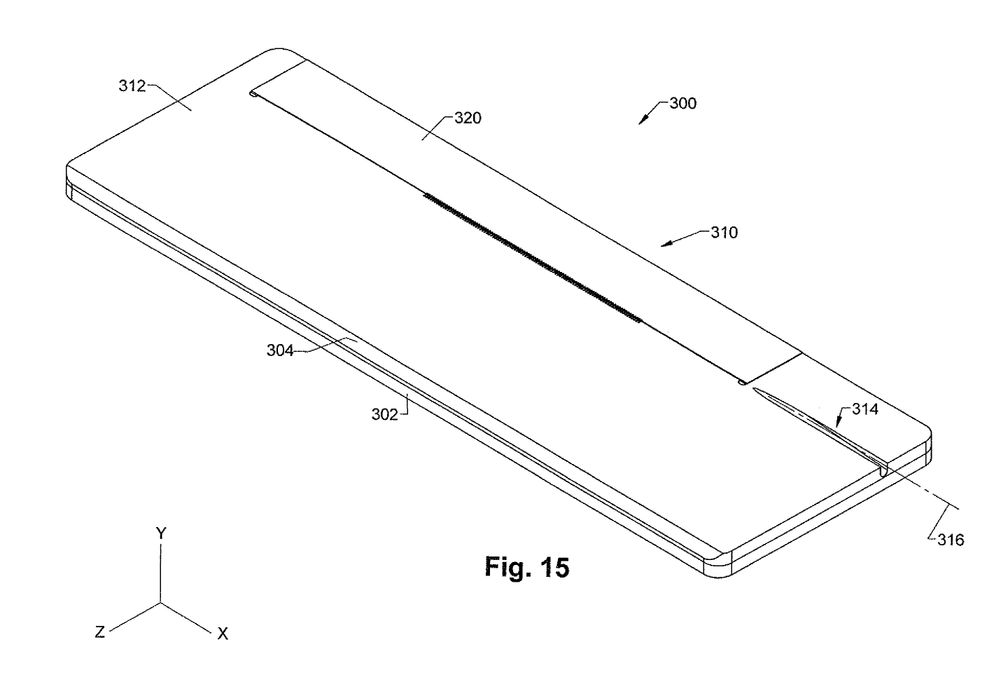

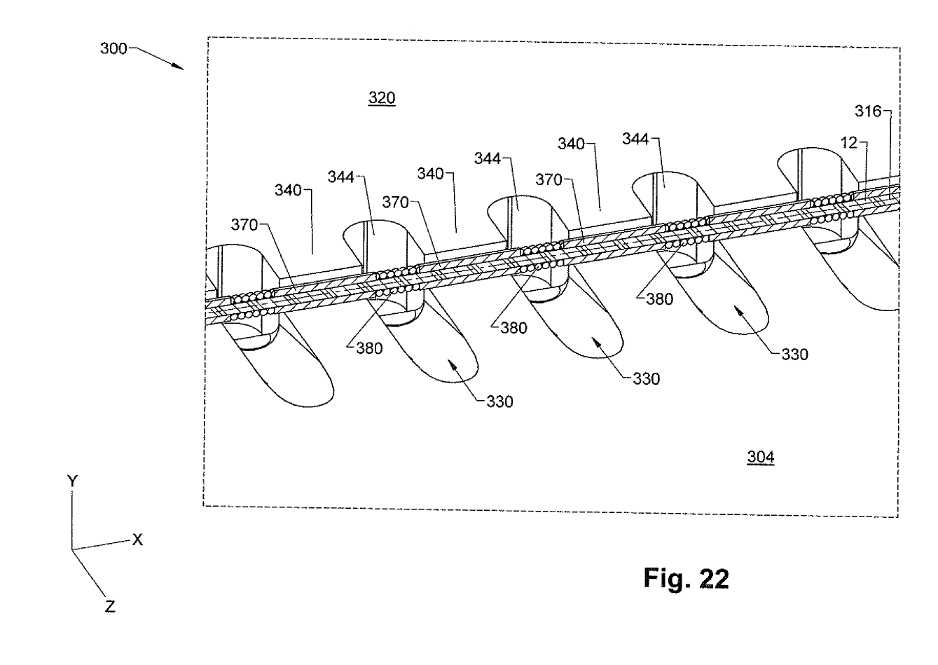

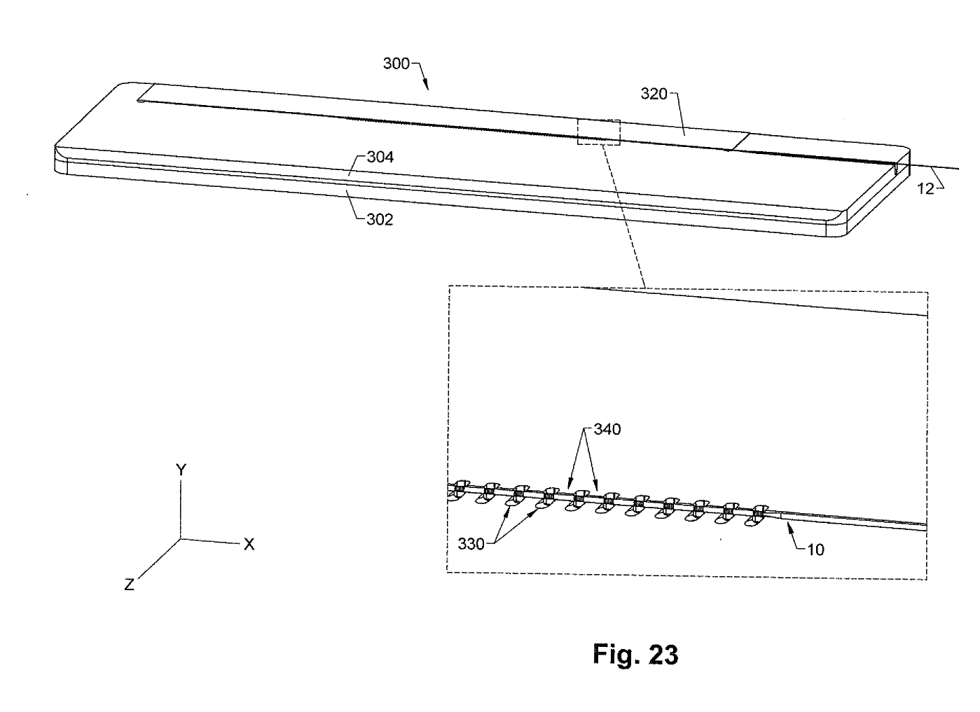

An apparatus 300 that forms a portion, in the form of a bonding fixture, of the system described herein is illustrated in FIGS. 15 to 23. Referring to FIG. 15, the apparatus 300 may, for example be used to support, orient, and position magnetic elements on a core member, such as a flexible elongated core member. According to one particular example, the apparatus 300 may be for supporting, orienting, and positioning magnetic elements on a guidewire, such as the guidewire 10 of FIG. 1. Particularly, the apparatus 300 may be used to support the guidewire 10 after the magnets 14 and spacers 16 are assembled onto the core 12 using the apparatus 100 of FIGS. 2 to 14. The apparatus 300 advantageously supports the assembled elements of the guidewire 10 so that the spacers 16 can be fixed to the core 12 by means, such as an adhesive. In this description, reference may be made to the X, Y, and Z axes or directions, which are shown in the drawings.

The apparatus 300 includes a base plate 302 and a top plate 304 that are connected or bonded together in a suitable manner. Alternatively, the apparatus 300 could include additional layers of material (i.e., plates) or could be constructed of a single layer/plate of material. According to one example construction, the top plate 304 may be constructed of, or be coated with, a polytetrafluoroethylene (PTFE) material, which is available commercially as Teflon® from the E. I. du Pont de Nemours and Company of Wilmington, Del. Any other suitable nonmagnetic material or combination of materials can be used.

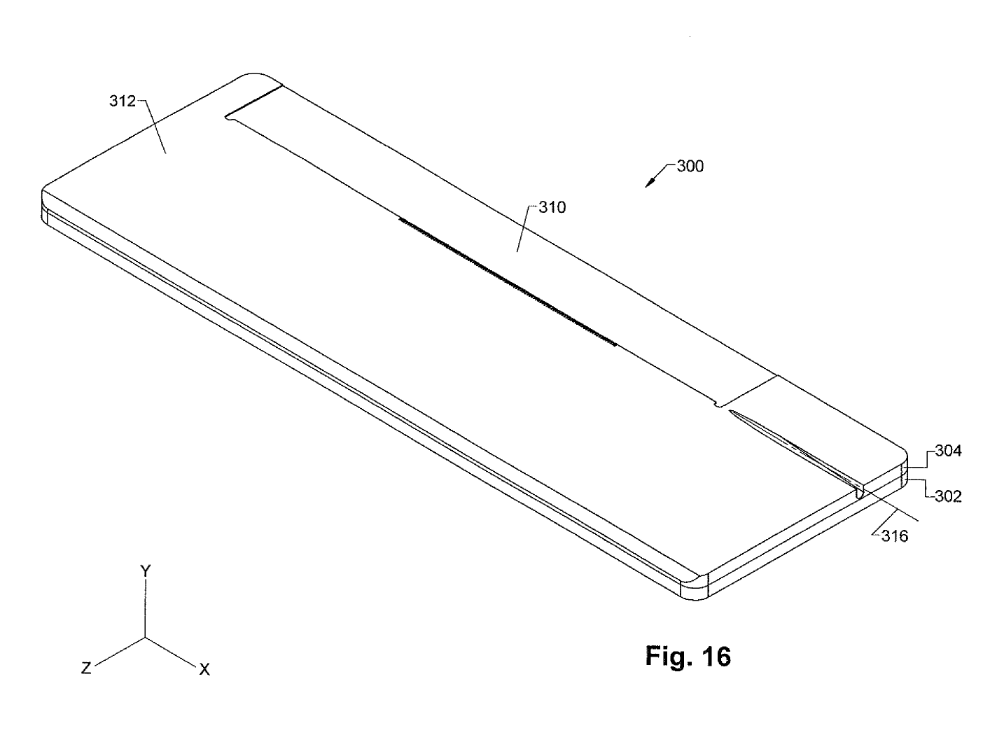

The apparatus 300 of the example embodiment of FIG. 15 has a generally rectangular configuration. Alternative shapes could be utilized. Referring to FIG. 16, the top plate 304 includes a pocket 310 that is recessed (e.g., via machining or molding) into a top surface 312 of the plate 304. The pocket 310 has a generally elongated rectangular configuration designed to receive a ferromagnetic/ferrimagnetic strip 320 that forms a portion of the apparatus 300. The strip 320 has a generally elongated rectangular configuration that is about the same as the configuration of the pocket 310. The strip 320 therefore fits into the pocket 310.

The apparatus 300 also includes a channel 314 that is recessed (Y-direction) into the top surface 312 of the top plate 304. The channel 314 is narrow and elongated in the X-direction, extending along an axis 316 that is parallel to and generally coincides with a lengthwise extending wall 332 of the pocket 310. As shown in FIG. 15, the channel 314 may have a tapered configuration for receiving and mating with a portion of the guidewire core (see, e.g., FIG. 1). The channel 314 is much bigger than the guidewire and serves to gradually direct the guidewire down to the level of the workbench. The channel 314 thus can help prevent the operator from accidentally folding the guidewire over the edge of the fixture and damaging the wire.

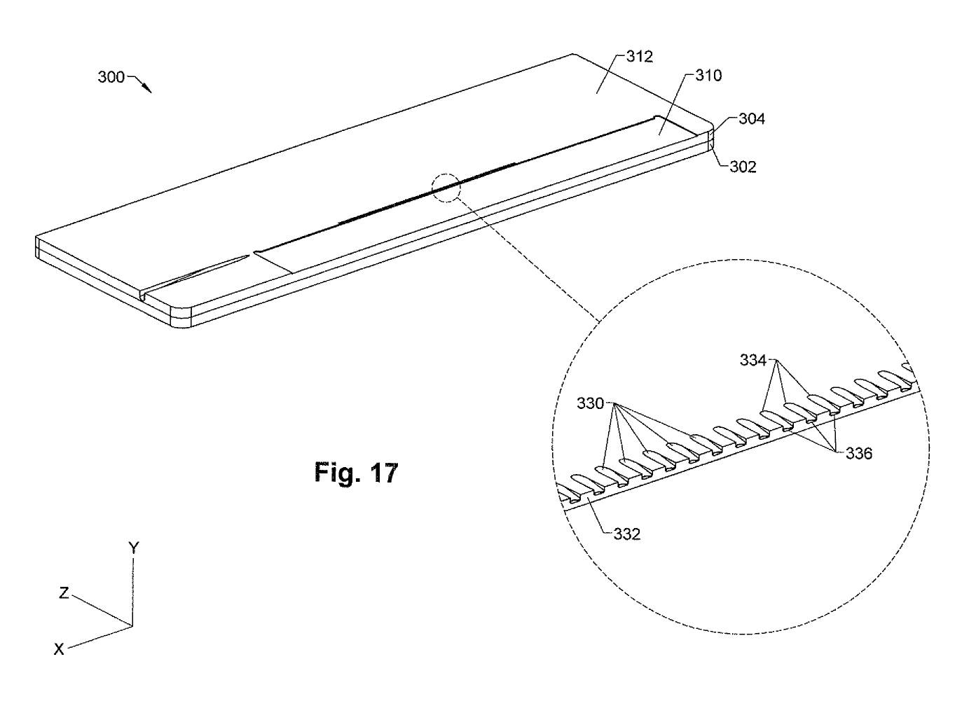

Referring to the magnified view of FIG. 17, the top plate 304 includes a plurality of angled slots 330 that are recessed into the top surface 312 of the top plate 304. The slots 330 are spaced longitudinally (X-direction) adjacent to and along the wall 332 of the pocket 310. Each slot 330 extends transverse (e.g., perpendicular, Z-direction) to the wall 332 and intersect the wall, creating a rectangular opening at each intersection. Each slot 330 has a first end 334 flush with the top surface 312 of the top plate 304. The first end 334 extends into the top plate at an angle (i.e., in a direction having both Y and Z components), terminating at a second end 336 at the intersection with the wall 332.

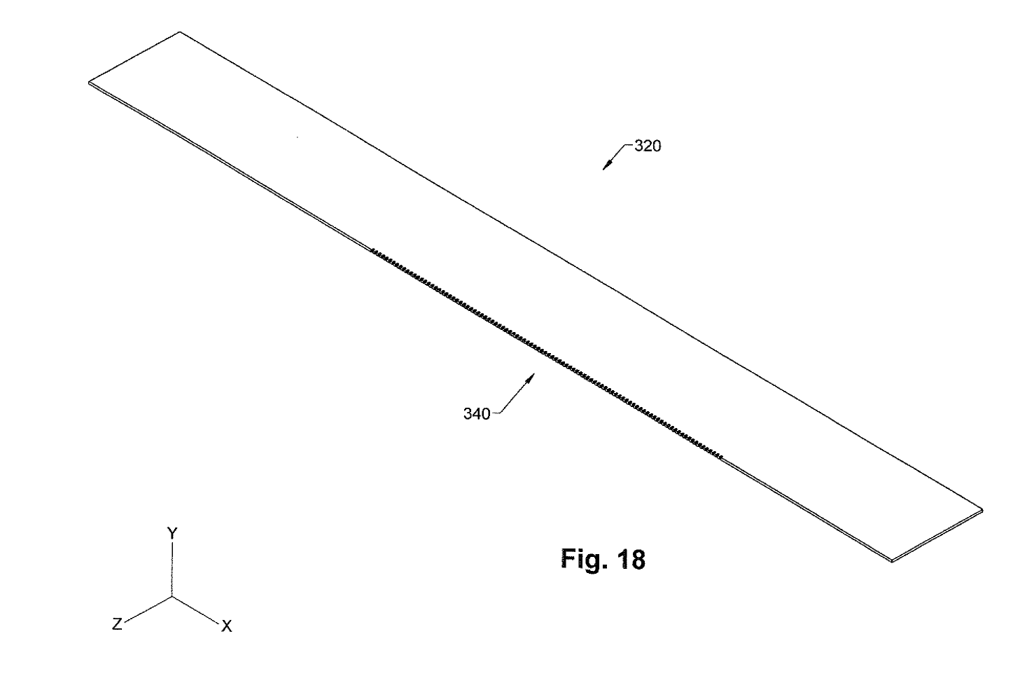

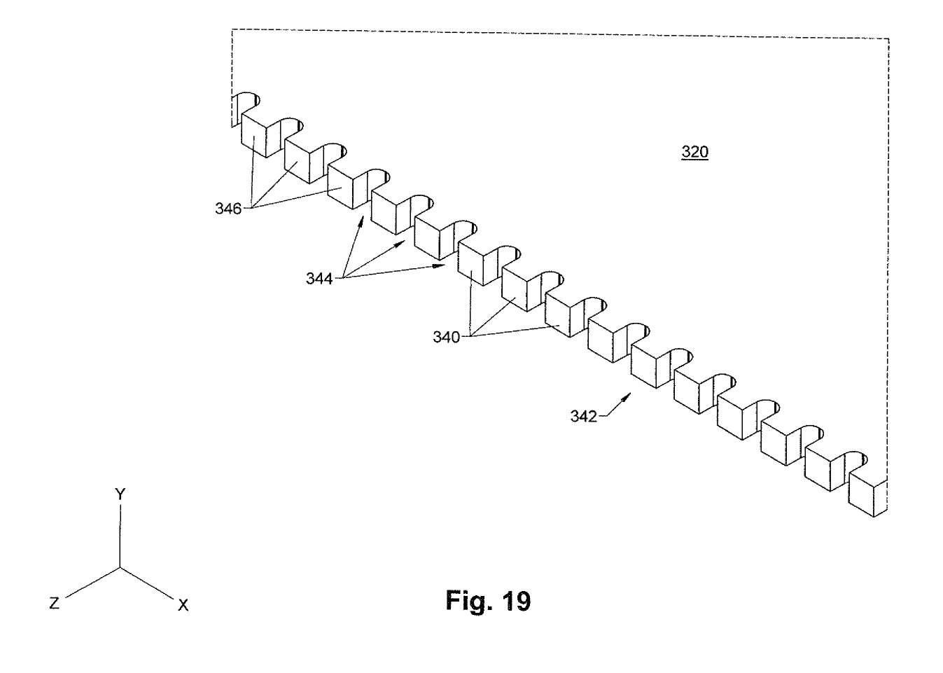

Referring to FIGS. 18 and 19, the strip 320 includes a plurality of teeth 340 that extend through the thickness (Y-direction) of the strip. The teeth 340 are spaced longitudinally (X-direction) adjacent to and along a lengthwise extending edge 342 of the strip 320. The teeth 340 are defined by a series of recesses 344 that extend into (Z-direction) the edge 342. The width (X-direction) of the recesses 344 is selected so that the resulting teeth 340 have a width (X-direction) that is about equal to the width (X-direction) of the second ends 336 of the slots 330.

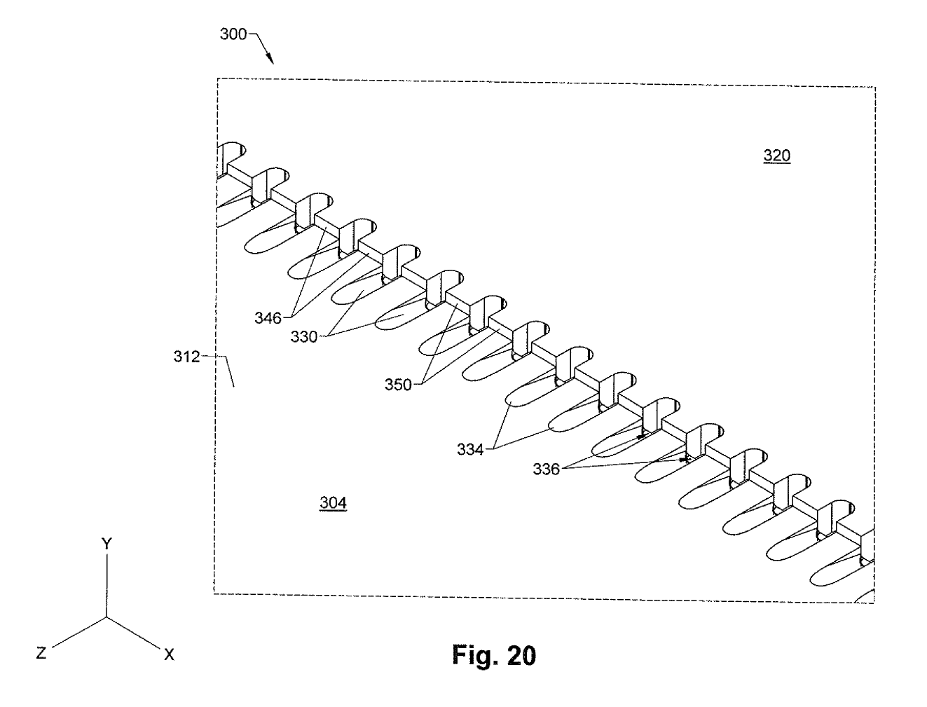

The spacing of the recesses 344 and the resulting teeth 340 is configured so that the recesses 344 extend across the second ends 336 of corresponding slots 330 when the strip 320 is assembled with the top plate 304 (see, e.g., FIG. 20). Similarly, end surfaces 346 of the teeth 340 mate with corresponding portions of the side wall 332 that extend between the slots 330. The dimensions of the strip 320 and the pocket 310 may require close tolerances in order to achieve this degree of alignment, especially considering the small dimensions of the teeth 340 and slots 330. Alternatively, accurate location of the recesses 344 relative to the slots 330 may be achieved by many other suitable means such as dowel pins, shoulder bolts, etc. As shown in FIG. 20, the strip 320 has a thickness that is greater than the depth of the pocket 310. This leaves an upper portion 350 of the end surfaces 346 of the teeth 340 exposed above the top surface 312 of the top plate 304.

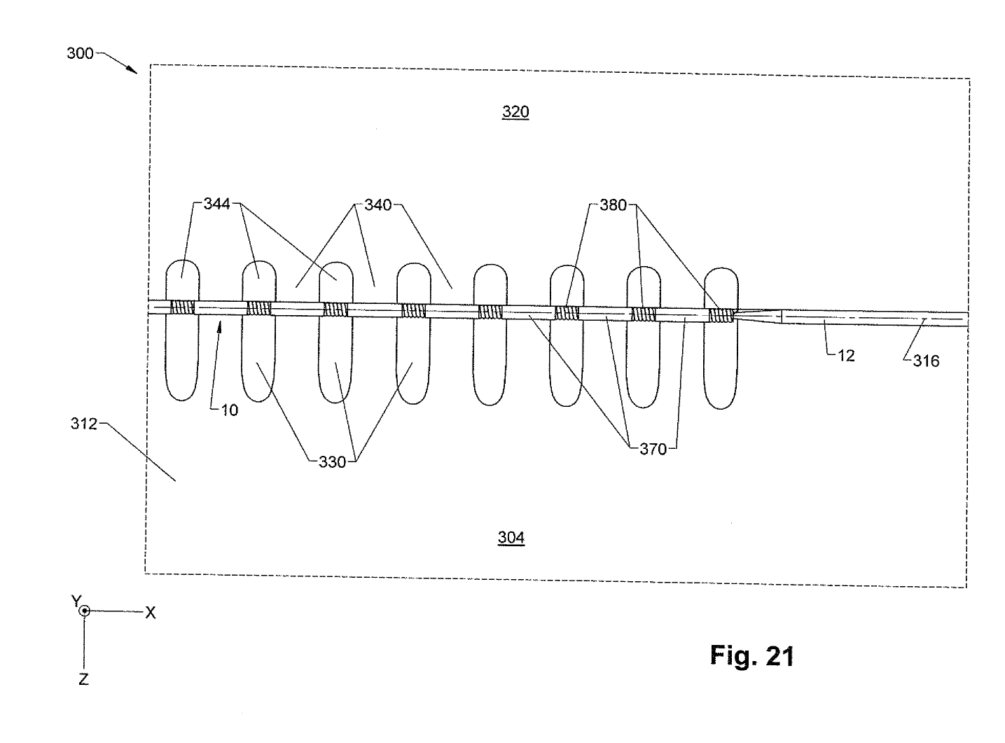

Referring to FIGS. 21 to 23, the apparatus 300 helps position and maintain the position of magnetic elements, e.g., permanent magnet elements or work pieces. In this embodiment, the elements are permanent magnet cylindrical beads 370, each of which has a central cylindrical throughbore that extends along its length. The beads 370 are axially magnetically polarized, i.e., the direction of magnetization of the beads 370 is along the length of beads 370. According to the invention, the teeth 340, and especially the exposed upper portions 350 of the end surfaces 346 of the teeth 340, serve as ferromagnetic/ferimagnetic elements that are spaced along the axis 316 and along the abutting surfaces 332 and 346 of the pocket 310 and strip 320, respectively.

When the beads 370 are introduced onto the top surface 312 of the top plate 304, they are drawn to the exposed upper portions 350 of the teeth 340 due to the magnetic attraction between the beads 370 and the teeth 340. The teeth 340 position the beads 370 in the desired manner, with the desired magnet-to-magnet spacing distance controlled by the established tooth-to-tooth spacing distance.

Those skilled in the art will appreciate that the position and orientation of the teeth 340 can be selected to produce a corresponding desired position and orientation of the beads 370. The apparatus 300 can position the beads at any orientation relative to each other.

In the embodiment of FIGS. 15 to 23, the slots 330 and recesses 344 are adapted to receive spacing elements 380, such as cylindrical coil spring spacers. The spacers 380 have a coiled wire construction that leaves an open, axially extending central aperture that extends along its length and is generally centered on the axis 316. The central aperture of the spacers 380 are thus axially aligned with the throughbores of the beads 370. The spacers 380 may be constructed of a ferromagnetic or a non-ferromagnetic material.

To use the apparatus 300, an assembled or partially assembled guidewire 10 is positioned on the top surface 312 of the top plate 304. The magnetic beads 370 are attracted to the teeth 340, which positions the guidewire such that the magnet beads 370 are positioned against the teeth. This leaves the springs 380 situated within the gaps created by slots 330 and recesses 344. Advantageously, the aligned slots 330 and recesses 344 leave the spacers suspended on the core 12, with little or no touching of the top plate 304 or strip 320. This allows for applying any adhesives (e.g., glue) used to fix the spacers 380 and, thus, the beads 370 on the core 12 without the risk of the adhesives wicking to the top plate 304 or strip 320 and bonding the assembled or partially assembled guidewire 10 to the apparatus 300.

Since the magnetic elements 14 (beads 370), spacer elements 16 (e.g., spring/coil spacers 380) and core 12 can be very small diameter items, they can also be fragile. Because of this, the attractive force between the beads 370 and the ferromagnetic/ferrimagnetic elements (upper portions 350 of teeth 340) cannot be so strong as to risk damage to the guidewire 10 during removal. Therefore, according to the invention, the ferromagnetic/ferrimagnetic elements (upper portions 350 of teeth 340) are selected to be strong enough to provide the desired orientation of the beads 370, but not so strong as to risk damaging the guidewire 10 during removal from the apparatus 300.

The level of magnetic attractive force between the beads 370 and ferromagnetic/ferrimagnetic elements (upper portions 350 of teeth 340) can be adjusted by modifying the size/shape of the ferromagnetic/ferrimagnetic elements and/or selecting a material for the strip 320 with either a higher or lower level of magnetic permeability. For example, a material such as 1008 cold rolled carbon steel has a high permeability and would produce a relatively high magnetic attractive force. On the other hand a material such as annealed 316 stainless steel, comparatively, has a much lower permeability and would produce a much lower magnetic attractive force. Other materials, such as full hard 302 stainless steel, have a permeability in between 1008 carbon steel and annealed 316 stainless steel. Therefore, full hard 302 stainless steel would produce a level of magnetic attractive force somewhere in between 1008 carbon steel and annealed 316 stainless steel.

Although the above described embodiment of apparatus 300 makes use of a ferromagnetic/ferrimagnetic member (strip 320) to position the beads 370 and hold the guidewire 10, those skilled in the art will appreciate that any suitable magnetic element(s) may be used to position the beads 370 and hold the guidewire 10. For example, one or more magnets could be used in place of or in combination with one or more ferromagnetic/ferrimagnetic members. The magnets used could be permanent magnets, electromagnets, or a combination of permanent magnets and electromagnets. If electromagnets are used, the electromagnets could be activated with a supplied electric current during assembly of the guidewire 10. While activated, the electromagnets would produce a magnetic field. The magnetic field would act to position the beads 370 and hold the guidewire 10 to facilitate one or more assembly steps. In this example, the assembly step comprises bonding the beads 370 and the spacers 380 to the core 12. After the one or more assembly steps are completed, the electromagnets could be deactivated by removing the supplied electric current. When the electromagnets are in the deactivated state, the electromagnets no longer produce a magnetic field, and the assembled guidewire 10 may be easily removed from the apparatus 300 without undue magnetic resistance. Advantageously, in this embodiment, the electromagnets could be electrically wired and/or switched so that the magnetic poles of each electromagnet are selectable, so that the apparatus 300 can adapt to a desired guidewire configuration.

We claim:

1. An apparatus for orienting magnetic elements for assembly on a flexible elongated core member, the apparatus comprising:
a plate for supporting the magnetic elements; and
a plurality of magnetic positioning elements secured to the plate and configured to position and orient the magnetic elements to facilitate assembly on the core member.

2. The apparatus recited in claim 1, wherein the plate comprises a channel recessed into a top surface of the plate, the positioning elements being configured to magnetically attract and position the magnetic elements in the channel.

3. The apparatus recited in claim 2, further comprising pockets for receiving the positioning elements, the pockets being recessed into a bottom surface of the plate opposite the top surface, the pockets being arranged to extend along a path that is parallel with the path of the channel.

4. The apparatus recited in claim 2, further comprising pockets recessed into a bottom surface opposite the work surface, the positioning elements being secured in the pockets.

5. The apparatus recited in claim 4, wherein the plate is a top plate, the apparatus further comprising a base plate attachable to the top plate to conceal and maintain the positioning elements in the pockets.

6. The apparatus recited in claim 2, wherein the core member comprises a guidewire core and the magnetic elements comprise magnetic beads, the positioning elements positioning and orienting the beads for receiving the guidewire core.

7. The apparatus recited in claim 6, wherein the channel is configured to receive spacer elements between the magnetic elements, the spacer elements being configured to receive the guidewire core and to space the magnetic elements along the guidewire.

8. The apparatus recited in claim 7, wherein the spacer elements comprise cylindrical coil spring spacers.

9. The apparatus recited in claim 7, wherein the central apertures of the spacer elements are axially aligned with throughbores of the magnetic beads when the spacer elements are received in the channel.

10. The apparatus recited in claim 7, wherein the spacers are constructed of one of a ferromagnetic material and a non-ferromagnetic material.

11. The apparatus recited in claim 2, further comprising a cover that is receivable by the plate, the cover comprising a channel that is presented toward the top surface and coextensive with the channel in the plate, the coextensive channels defining a cylindrical space that is adapted to guide the core member through the magnetic elements positioned in the cylindrical space.

12. The apparatus recited in claim 11, wherein the cover is made of an optically clear plastic.

13. The apparatus recited in claim 11, wherein cover serves to help maintain the positions of the beads and spacers so that they do not become dislodged by the insertion of the core.

14. The apparatus recited in claim 2, wherein the channel extends the entire length of the plate through first and second ends of the plate.

15. The apparatus recited in claim 1, wherein the positioning elements are arranged with like poles adjacent to each other.

16. The apparatus recited in claim 1, wherein the magnetic elements comprise at least one of permanent magnets, ferromagnetic elements, and ferrimagnetic elements.

17. The apparatus recited in claim 1, wherein the magnetic elements comprise hollow cylindrical beads, the apparatus being adapted to guide the core member through the beads.

18. The apparatus recited in claim 1, wherein the positioning elements comprise permanent magnets.

19. The apparatus recited in claim 1, wherein the positioning elements comprise electromagnets.

20. The apparatus recited in claim 19, wherein the electromagnets could be electrically wired and/or switched so that the magnetic poles of each electromagnet are selectable, so that the apparatus 300 can adapt to a desired guidewire configuration.

21. The apparatus recited in claim 1, wherein the positioning elements comprise portions of a magnetic strip of material.

22. The apparatus recited in claim 21, wherein the strip includes a plurality of teeth that are spaced longitudinally along a lengthwise extending edge of the strip, each tooth defining a positioning element.

23. The apparatus recited in claim 22, wherein the teeth are defined by a series of recesses that extend into the edge of the strip.

24. The apparatus recited in claim 22, wherein the plate includes a plurality of angled slots that are recessed into a top surface of the plate.

25. The apparatus recited in claim 24, wherein each angled slot has a first end flush with the top surface of the plate, the angled slot extending into the plate at an angle terminating at a second end at an intersection with an end wall defined by the slot.

26. The apparatus recited in claim 25, wherein the magnetic strip is secured to the plate so that the teeth are positioned between the angled slots and extend above the top surface of the plate.

27. The apparatus recited in claim 26, wherein the teeth position the beads on the top surface between the angled slots.

28. The apparatus recited in claim 27, wherein the slots are adapted to receive spacing elements and position the spacing elements between the magnetic elements.

29. The apparatus recited in claim 1, wherein magnetic elements are selected to be strong enough to provide the desired orientation of the beads, but not so strong as to risk damaging the guidewire during removal from the apparatus.
